(19) United States
(12) Patent Application Publication
(10) Pub. No.: US 2016/0232634 A1
(43) Pub. Date: Aug. 11, 2016

(54) PROCESS TO ENABLE SOLUTION ACQUISITION WITH SaaS MODEL

(71) Applicant: NORTE CRED FORMALIZAR SOLUÇÕES TECNOLÓGICAS LTDA, São Paulo, SP (BR)

(72) Inventor: João Batista De Akneuda Fibseca, São Paulo (BR)

(21) Appl. No.: 15/021,783

(22) PCT Filed: Sep. 8, 2014
(86) PCT No.: PCT/BR2014/000315

§ 371 Date: Mar. 14, 2016

(30) Foreign Application Priority Data
Sep. 12, 2013 (BR) 132013023367-5

(51) Int. Cl. G06Q 50/18; G06Q 40/06

(52) U.S. Cl. CPC G06Q 50/184; G06Q 40/06

(57) ABSTRACT

A method is described for allowing solution acquisition on the basis of the SaaS model by potential customers, the paperless solution management software aiming at introducing a unit counter of transactions executed, allowing the cost of each transaction to be quantified and billed, instead of a cash payment for use licenses.

### FIELD OF THE INVENTION

This certificate of addition describes a process to enable the acquisition solution with SaaS model by potential customers, the managing software of paperless solution, aiming to insert a unit counter of transactions effected in order to be able to quantify the price cost of each transaction, and not by cash payment of use licenses anymore.

### BACKGROUND

Saas: Software as a service. English Software as a service (SaaS), is a form of distribution and marketing of software. In the SaaS model the software provider is responsible for all the necessary structure for the delivery of the system (servers, connectivity, attention to information security) and the client uses the software via internet, paying a fee of the service offered.

### SaaS BENEFITS

Compared to the traditional model of distribution of software products (in which the customer buys the use license and is responsible for establishing and maintaining production) we can highlight the following advantages of the Saas model for customers:

It does not require the client to create a structure and enable professionals to keep the system running, allowing it to focus on your business.

The SaaS allows a gradual approach to implementation, and can start with a few licenses and expand as have a positive return on investments while reducing risk and time to return on investments. It allows you to increase or decrease the licenses over time, according to business needs.

The deployment of SaaS can be made with little dependence on TI teams of the company, not competing priority with other systems and can reduce deployment times.

The following charging models in SaaS are common:
Recurrent value (usually monthly) proportional to the number of used licenses.
Recurrent value (usually monthly) proportional to the use (example: email marketing release).
Advertising (banners).
Freemium—with free and paid versions according to the features available.
Note a big difference in all cases of the traditional model is the low initial outlay and paid over time by the use of the product.

Sustainability is the ability to sustain or support one or more conditions, displayed by something or someone. It is a characteristic or condition of a process or a system that allows their stay, at a certain level for a certain period.

This concept has become a principle according to which the use of natural resources to satisfy present needs can not commit to meeting the needs of future generations, and that needed the bond of sustainability in the long term a “long term” of indefinite term in principle.

Sustainability can also be defined as the ability of human being to interact with the world, preserving the environment not to compromise the natural resources of future generations.

In order to preserve the environment not to compromise the natural resources for future generations, it was conceived the PROCESS OF EXTINCTION OF PAPER IN TRANSACTIONS ORIGINATED ELECTRONICALLY THROUGH THE BIOMETRICS HANDWRITTEN WITH VALID LEGAL VALIDITY NAMED SOLUTION FORMALIZE PAPERLESS, object of Invention of the patent BR102012032451-2, filed on Dec. 19, 2012.

In the SaaS model, the software used by customers are paid according to the used amount of transactions, with little initial investment, this enabling any biometrics paperless project.

In practice, the object of this addition certificate allows customers to acquire the paperless solution in the same way they rent a car without having to pay a daily, that is, only pay for the kilometers rotated. (SaaS)

In the traditional model, the form of acquisition is use license, the software and biometric hardware can only be sold with payment in cash, and a very high initial investment for the customer, making unviable projects.

The acquisition form of the process object of this addition Saas is a software as a service, that is, in the biometrics software the customer only pays what he uses, in the biometrics hardware the customer can set the payment in installments, being a very low investment, making it possible the deployment of any projects.

Having described and illustrated this addition, it is to be understood that it can undergo numerous modifications and variations in its embodiment, provided that such modifications and variations do not depart from its spirit and scope, such as defined in the set of claims.

1- “PROCESS TO ENABLE ACQUISITION SOLUTION WITH SaaS MODEL”, characterized by the fact that in the managing software of paperless solution, aiming to insert a unit counter of transactions effected, aiming to insert a unit counter of transactions effected in order to be able to quantify the price cost of each transaction, and not by cash payment of use licenses anymore.
